(19) United States
(12) Patent Application Publication
(10) Pub. No.: US 2017/0371087 A1
(43) Pub. Date: Dec. 28, 2017

(54) Displays with Ramped Light Guide Layers and Multidirectional Light-Emitting Diodes

(71) Applicant: Apple Inc., Cupertino, CA (US)

(72) Inventors: Chenhua You, San Jose, CA (US); Abdeslam Hafidi, Cupertino, CA (US); Jun Qi, Cupertino, CA (US); Mingxia Gu, San Jose, CA (US); Victor H. Yin, Cupertino, CA (US)

(21) Appl. No.: 15/260,904

(22) Filed: Sep. 9, 2016

Related U.S. Application Data
(60) Provisional application No. 62/353,510, filed on Jun. 22, 2016.

(51) Int. Cl. F21V 8/00; G02F 1/1335; G06F 3/041; G02F 1/1368; G02F 1/1333

(52) U.S. Cl. CPC G02B 6/0021; G02B 6/0068; G02B 6/0073; G02F 1/133621; G02B 6/0016; G02F 1/13338; G02F 1/133528; G02F 1/1368; G06F 3/0412; G02F 1/133514

(57) ABSTRACT

A display such as a liquid crystal display may have an array of pixels that is illuminated using backlight illumination from a backlight. The backlight may have a light guide plate that distributes light from light-emitting diodes across the display. The light-emitting diodes may be overlapped by the light guide plate and may emit light into portions of the light guide plate that have ramped profiles. Light-emitting diodes for the backlight may have multiple light-emitting diode dies mounted on common package substrates. Reflective walls may be formed between the light-emitting diode dies on a substrate. Phosphor may cover the dies. The light-emitting diodes may contain four light-emitting diode dies that emit light in four different directions. Two or more of the dies may emit light of different colors. Light may be emitted into the corners of rectangular light distribution regions of a light guide plate.

The application claims the benefit of provisional patent application No. 62/353,510, filed Jun. 22, 2016, which is hereby incorporated by reference herein in its entirety.

### BACKGROUND

This relates generally to electronic devices, and more particularly, to electronic devices with displays.

Electronic devices often include displays. For example, cellular telephones and portable computers often include displays for presenting information to a user.

Displays such as liquid crystal displays may include backlight units. A backlight unit may include a light source and a light guide plate for distributing light from the light source across the display.

It can be challenging to form a satisfactory backlight. If care is not taken, a backlight unit may exhibit undesirable hotspots or may not allow backlight illumination intensity to be locally adjusted.

### SUMMARY

A display such as a liquid crystal display may have an array of pixels that is illuminated using backlight illumination from a backlight. The backlight may have a light guide plate that distributes light from light-emitting diodes.

The light-emitting diodes in the backlight may be overlapped by the light guide plate and may emit light laterally into portions of the light guide plate that have ramped profiles. Each light-emitting diode may supply light to an elongated light distribution region. The light distribution regions may extend parallel to horizontal or vertical edges of the display.

Light-emitting diodes for the backlight may have multiple light-emitting diode dies mounted on common package substrates. Reflective walls may be formed between the light-emitting diode dies on a substrate. Phosphor may cover the dies. The light-emitting diodes may each contain two light-emitting diode dies or four light-emitting diode dies that emit light respectively in two or four different directions. Two or more of the dies may emit light of different colors. Light may be emitted into the corners of rectangular light distribution regions of a light guide plate.

### BRIEF DESCRIPTION OF THE DRAWINGS

FIG. 1 is a cross-sectional side view of an illustrative backlit display in accordance with an embodiment.

FIG. 2 is a cross-sectional side view of an illustrative light guide layer having ramped portions in accordance with an embodiment.

FIG. 3 is a top view of an illustrative display showing how individually adjustable light-emitting diodes may supply illumination to different regions of a light guide layer with ramped portions in accordance with an embodiment.

FIGS. 4 and 5 are cross-sectional side views of illustrative light guide layers with ramped portions in accordance with an embodiment.

FIG. 6 is a cross-sectional side view of an illustrative backlight unit having a light guide layer that is illuminated by multidirectional light-emitting diodes in accordance with an embodiment.

FIG. 7 is a diagram showing how four light-emitting diode dies may be packaged in a common package to create a multidirectional light-emitting diode in accordance with an embodiment.

FIG. 8 is a diagram showing how two light-emitting diode dies may be packaged in a common package to create a multidirectional light-emitting diode in accordance with an embodiment.

FIG. 9 is a top view of an illustrative light guide layer that is being provided with illumination from packaged light-emitting diodes that each include four light-emitting diode dies in accordance with an embodiment.

FIG. 10 is a top view of an illustrative light guide layer that is being provided with illumination from packaged light-emitting diodes that each include two light-emitting diode dies in accordance with an embodiment.

FIG. 11 is a top view of an illustrative light distribution region in a light guide layer showing how the density of light extraction features on the light guide layer may be varied to as a function of position within the light distribution region to ensure that uniform backlight illumination is produced in accordance with an embodiment.

FIGS. 12 and 13 are diagrams showing how packaged multidirectional light-emitting diodes may be fabricated in accordance with an embodiment.

FIGS. 14 and 15 are perspective views of illustrative packaged multidirectional light-emitting diodes in accordance with an embodiment.

FIG. 16 is a cross-sectional side view of an illustrative light guide layer with ramped portions that is being provided with light from a multidirectional light-emitting diode in accordance with an embodiment.

FIG. 17 is a cross-sectional side view of an illustrative flip-chip light-emitting diode in accordance with an embodiment.

FIG. 18 is a cross-sectional side view of an illustrative light-emitting diode with side microstructures in accordance with an embodiment.

FIG. 19 is a cross-sectional side view of an illustrative light-emitting diode with a top metal layer in accordance with an embodiment.

FIGS. 20 and 21 are cross-sectional side views of illustrative light-emitting diodes with slanted edge surfaces in accordance with an embodiment.

FIG. 22 is a cross-sectional side view of an illustrative light-emitting diode with a patterned distributed Bragg reflector layer in accordance with an embodiment.

### DETAILED DESCRIPTION

Electronic devices such as cellular telephones, computers, wristwatches, media players, televisions, and other electronic devices may include displays. The displays may be used to display images for a user and may be backlit.

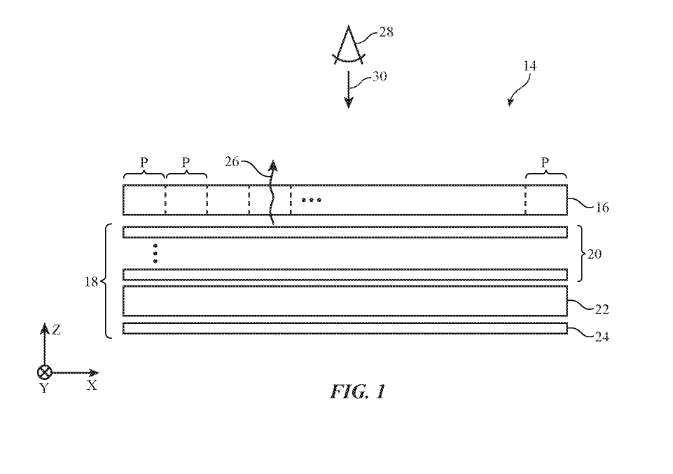

A cross-sectional side view of an illustrative backlit display for an electronic device is shown in FIG. 1. Display 14 of FIG. 1 may produce images for viewing in direction 30 by a viewer such as user 28. Display 14 may be a touch sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Display 14 may include backlight structures such as backlight unit 18 for producing backlight illumination 26. Pixels P may be formed in an array in a display module such as display module 16. Display module 16, which may sometimes be referred to as a display layer or a display, may be an electrophoretic display, a liquid crystal display, or other display that has an array of individually controlled light modulating pixels. With one illustrative configuration display module 16 may be a liquid crystal display module having upper and lower polarizers, layers such as a color filter layer and a thin-film transistor layer between the upper and lower polarizers, and a layer of liquid crystal material between the color filter layer and thin-film transistor layer. Pixel electrodes on the thin-film transistor layer may be used to apply electric fields to portions of the liquid crystal layer associated with pixels P and thereby control light transmission (i.e., transmission of backlight illumination 26) through layer 16. In general, display module 16 may be formed from any suitable backlit display panel with an array of pixels for presenting images to user 28. The use of a liquid crystal display arrangement for forming display 14 is merely illustrative.

Backlight unit 18 (sometimes referred to as a backlight) may include a light guide layer such as light guide layer 22. Light guide layer 22, which may sometimes be referred to as a light guide plate, may be formed from a transparent material such as molded plastic (e.g., polymethylmethacrylate or other suitable polymer). Light guide plate 22 may have a planar shape (e.g., a shape that lies in the X-Y plane of FIG. 1). Light from one or more light-emitting diodes or other suitable light sources may be emitted into light guide plate 22 and may be distributed laterally (e.g., in dimensions X and Y in the example of FIG. 1) in accordance with the principal of total internal reflection.

The upper and/or lower surfaces of light guide plate 22 may include light scattering features such as bumps, ridges, or other protrusions, pits, grooves, or other recesses, printed ink light scattering features, embedded light scattering structures such as bubbles or light-scattering particles, or other structures that help scatter light out of layer 22. Light that is scattered out of layer 22 and that travels upwards in direction Z may serve as backlight illumination 26. Reflector 24 may be located under light guide plate 22 and may be used to reflect light that has scattered downward out of layer 22 in direction −Z back in the upward direction (+Z) to serve as backlight illumination 26. Optical films 20 in backlight unit 18 may be interposed between light guide layer 22 and display module 16. Films 20 may include one or more layers such as a diffuser layer to homogenize backlight illumination 26, prism films for collimating backlight illumination 26, and compensation films for improving off-axis viewing performance. If desired, these films may be incorporated into other portions of display 14. For example, a compensation film may be incorporated into a polarizer layer in display module 16, etc.

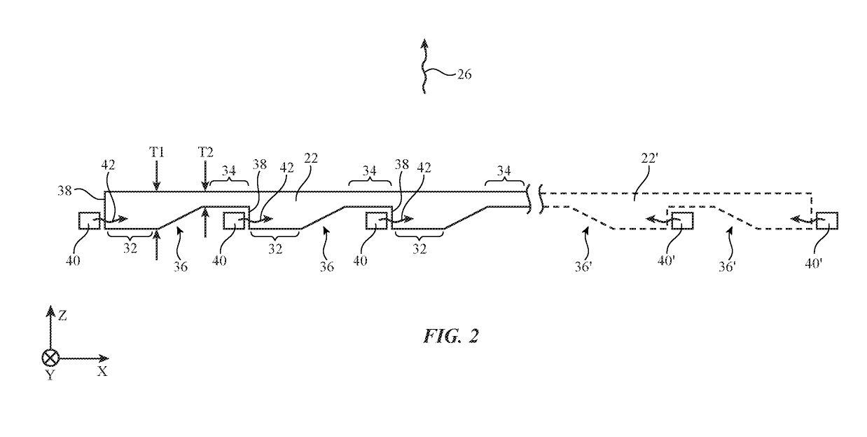

FIG. 2 is a cross-sectional side view of an illustrative light guide plate of the type that may be used in backlight 18. As shown in FIG. 2, light-emitting didoes 40 may be mounted under light guide plate 22. For example, light guide plate 22 may have a rectangular shape that extends under a rectangular array of pixels P and light-emitting diodes 40 (or nearly all of light-emitting diodes 40) may be overlapped by light guide plate 22.

Light guide plate 22 may have ramped regions (e.g., regions in which the upper and lower surfaces of light guide plate 32 are not parallel to each other so that they exhibit tapered profile) such as ramped regions (ramps) 36. Light guide plate 22 may have thicker regions such as regions 32 that receive light 42 via edge surfaces 38 and may have thinner regions 34 that help laterally distribute the received light over display 14. Ramped regions 36 may have a thickness that tapers from the larger thickness T1 of regions 32 to the smaller thickness T2 of regions 34. With one illustrative configuration, surfaces 38 of light guide plate may be formed on thicker portions of light guide plate 22 such as thicker regions 32. Ramped regions 36 may have thickness T1 where ramped regions 36 join regions 32 and may have thickness T2 where ramped regions 36 join regions 34. Ramped regions 36 may have planar surfaces, concave surfaces, convex surfaces, or surfaces of other suitable shapes (e.g., regions 36 may be characterized by other straight and/or curved profiles). The illustrative configuration of FIG. 2 in which regions 36 have tapered profiles with straight edges is merely illustrative.

Thicknesses T1 and T2 may have any suitable values. As an example, T1 may be 2 mm, more than 1 mm, less than 3 mm, or other suitable value, thickness T2 may be 0.7 mm, more than 0.2 mm, less than 1.2 mm, or other suitable value, and the lateral dimensions of regions 32, 36, and 34 may be about 5 mm, more than 1 mm, 4-20 mm, less than 2 cm, less than 3 cm, or other suitable sizes.

If desired, ramped regions 36 of light guide plate 22 may include ramps that taper in opposing directions. For example, some of ramps 36 may taper towards the right and other ramps (e.g., ramps 36′ in light guide plate portion 22′ of FIG. 2, which are receiving light from light-emitting diodes 40′) may taper to the left.

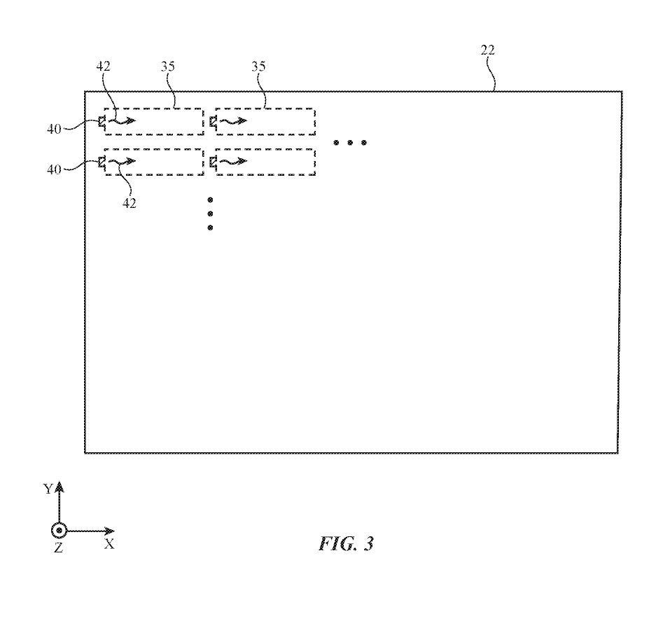

The areas of light guide plate 22 that receive light 42 from light-emitting diodes 40 may be elongated, as shown by illustrative light distribution regions 35 of FIG. 3. Each light-emitting diode 40 may be individually controlled to implement a local dimming scheme for display 14 (e.g., to increase dynamic range) and/or to conserve power by dynamically depowering unneeded portions of backlight 18.

There may be any suitable number of light-emitting diodes 40 and associated light distribution regions 35 in light guide plate 22 (e.g., 2-100 rows of regions 35, more than 2 rows of regions 35, fewer than 40 rows of regions 35, fewer than 1000 rows of regions 35, 2-100 columns of regions 35, more than 2 columns of regions 35, fewer than 40 columns of regions 35, fewer than 1000 columns of regions 35, etc.). In the illustrative example of FIG. 3, all light-emitting diodes 40 are emitting light 42 in the same direction (the positive X direction). If desired, tapered regions 36 may be oriented in both the X and −X directions and light 42 may be emitted into light guide plate 22 in both the X and −X directions. Regions 35 may be elongated along the X dimension or may be elongated along the Y dimension.

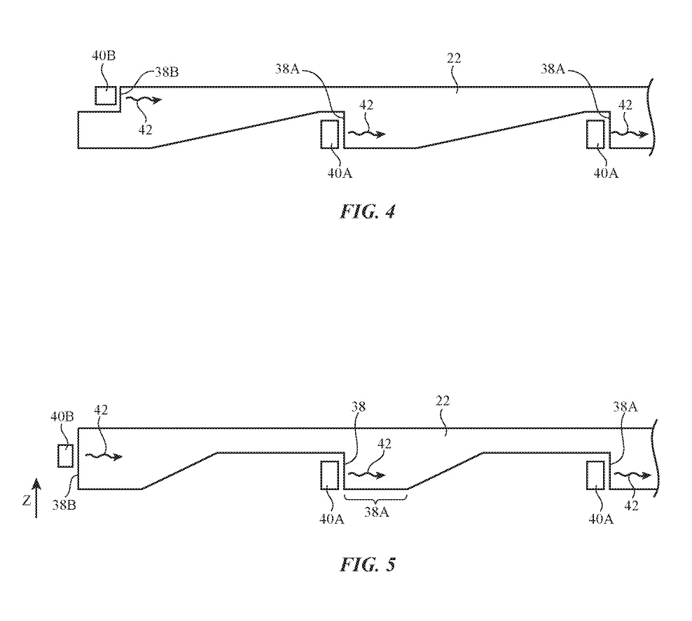

FIGS. 4 and 5 are cross-sectional side views of illustrative light guide plates showing how the locations of light-emitting diodes 40 and the shapes of the portions of light guide plate 22 that receive light 42 may have various different configurations. In the example of FIG. 4, light 42 from diodes 40A is emitted into vertical edge surfaces 38A that extend partway into light guide plate 22 from the lower surface of light guide plate 22 and light 42 from diode 40B is emitted into vertical portion 38B of a notch in the upper surface of light guide plate 22 at the end of light guide plate 22. In the example of FIG. 5, light 42 from diodes 40A is emitted into vertical edge surfaces 38A that extend partway into light guide plate 22 from the lower surface of light guide plate 22 and light 42 from diode 40B is emitted into edge surface 38B at the end of light guide plate 22. Other arrangements and/or combinations of these arrangements may also be used in forming edge surfaces for receiving light 42 from a light guide plate with ramped portions. The arrangements of FIGS. 2, 4, and 5 are illustrative.

If desired, light-emitting diodes 40 may emit light in multiple directions. For example, each light-emitting diode 40 may contain multiple crystalline semiconductor light-emitting diode dies mounted in a common package (e.g., multiple dies that are soldered to a common printed circuit board package substrate). Each of the light-emitting diode dies in the package of the light-emitting diode may be oriented in a different direction. This allows light 42 to be emitted into light guide plate 22 at the corners of rectangular light distribution regions (e.g., rectangular regions that extend in an array across plate 22). The light distribution regions may be formed from tiled light guide plate members (separate plates arranged in a tiled pattern) or may be formed from a single light guide plate that has an array of openings, ramped portions, or other structures for receiving light from light-emitting diodes 40.

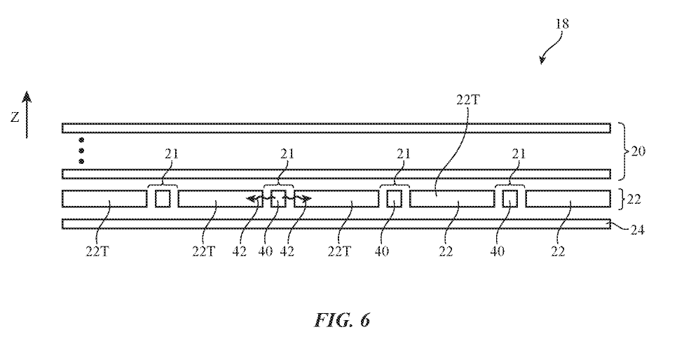

As shown in FIG. 6, for example, light guide plate 22 may have a plurality of light-distribution regions 22T that receive light 42 from multidirectional light-emitting diodes 40 that are located in an array of respective openings 21 in light guide plate 22. Regions 22T may be formed from separate tiled light guide members (plates) or may be portions of an integral light guide plate.

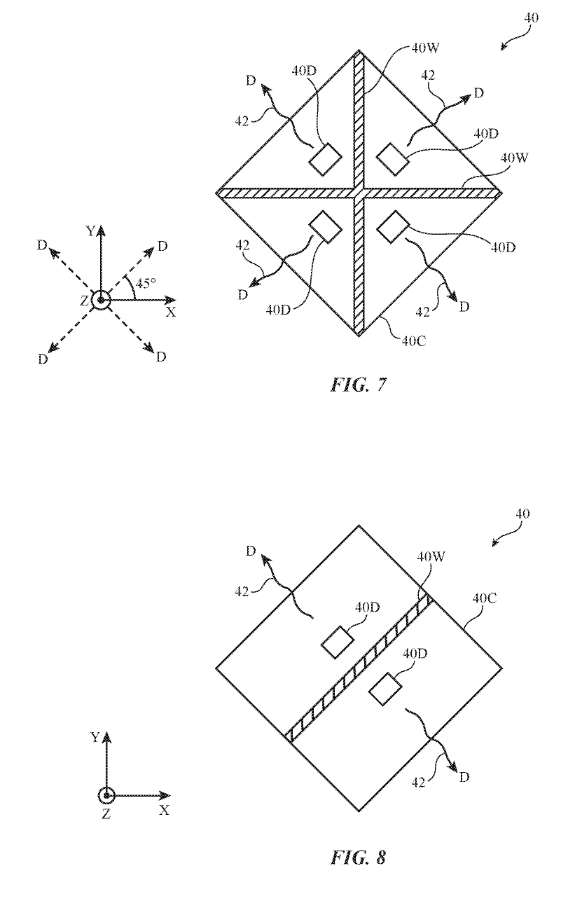

FIGS. 7 and 8 are top views of illustrative multidirectional light-emitting diodes 40. In the illustrative configuration of FIG. 7, light-emitting diode 40 has four light-emitting diode dies 40D, each of which emits light 42 in a different one of four directions D. The direction in which light 42 is emitted by each light-emitting diode die 40D may be separated from the direction in which light 42 is emitted by the next light-emitting diode die 40D by 90° , so that light-emitting diode 40 emits light over 360° . Dies 40D may be mounted to a common printed circuit board substrate 40C.

Reflective walls 40W may be used to help reflect light 42 outwardly into light guide plate 22 from each die 40D, as illustrated by reflected light rays. Wall structures such as walls 40W may sometimes be referred to as reflectors or reflective wall structure and may be formed from white polymer (e.g., a resin with titanium dioxide particles or other reflective material) or other suitable reflective structures. A photoluminescent material (e.g., a phosphor, quantum dots, etc.) may be formed over light-emitting diode dies 40D and substrate 40C to adjust the color and/or intensity of light 42 (e.g., to produce white light from a colored light-emitting diode, to adjust the white point of light 42, etc.). As shown in FIG. 8, packaged light-emitting diode 40 may, if desired, have a wall such as wall 40W that runs straight across substrate 40C between a pair of light-emitting diode dies 40D. Dies 40D in FIG. 8 may emit light 42 in opposite directions D.

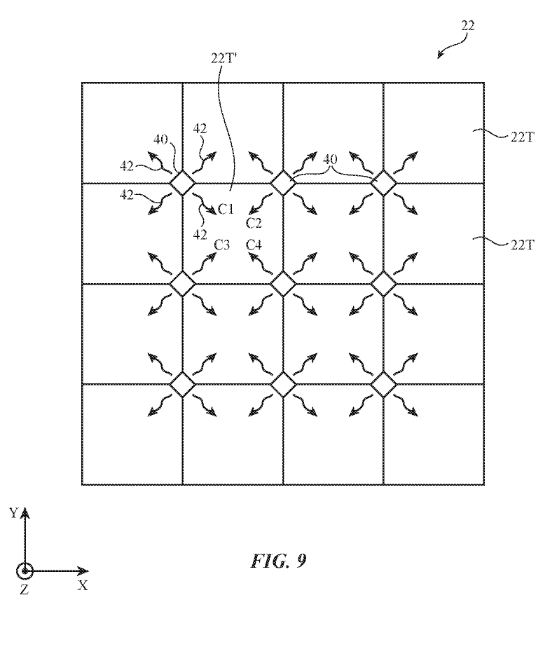

FIG. 9 shows how light guide plate 22 may have multiple tiled square (rectangular) light distribution regions 22T (formed from separate planar members or formed as an integral light guide plate). Packaged multidirectional light-emitting diodes 40 such as four-direction light-emitting diode 40 of FIG. 7 may be located at square-shaped openings at the corners of regions 22T and may supply light 42 to light guide plate 22.

The dies 40D in light-emitting diodes 40 may all emit the same color of light or may have different colors. The different colors may include, for example, different colors of white (e.g., CIE Standard Illuminant D65, D50, etc.), and/or colors such as red, blue, green, yellow, etc. In configurations in which light-emitting diodes 40 have dies 40D of different colors, the color of background illumination produced by each region 22T may be adjusted by varying the relative contribution of light from each die 40D. As shown in FIG. 9, for example, the color of backlight produced by region 22T′ may be adjusted by adjusting the relative intensity of light from the four dies 40D associated with the diodes 40 at the four corners of region 22T′. In the FIG. 9 example, these dies 40D produce light of four different respective colors C1, C2, C3, and C4, but, if desired, two or three of the dies may produce light of the same color or dies 40D may all be of the same color.

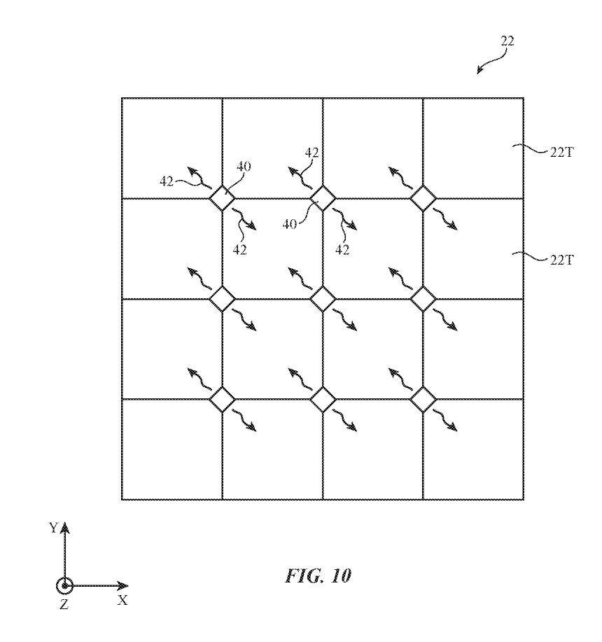

FIG. 10 shows how regions 22T of light guide plate 22 may be supplied with light 42 from packaged multidirectional light-emitting diodes 40 such as two-direction light-emitting diode 40 of FIG. 8. Each of the dies 40D in diode 40 of FIG. 8 may produce light 42 of the same color or each diode 40 may have first and second dies 40D that produce first and second respective different colors.

To help create uniform backlight illumination 26, the light-scattering structures in light guide plate 22 may be denser at locations where the light from light-emitting diodes 40 has decreased in intensity due to propagation through layer 22 and associated scattering of light out of layer 22 to serve as backlight illumination 26. The light-scattering structures may be less dense at locations where the intensity of the light from light-emitting diodes 40 is greatest (e.g., at the exit of each light-emitting diode 40). As shown in the configuration of FIG. 11, for example, light-scattering features may be most dense at the centers of regions 22T and may be less dense near the corners of regions 22T where light 42 is received from light-emitting diodes 40.

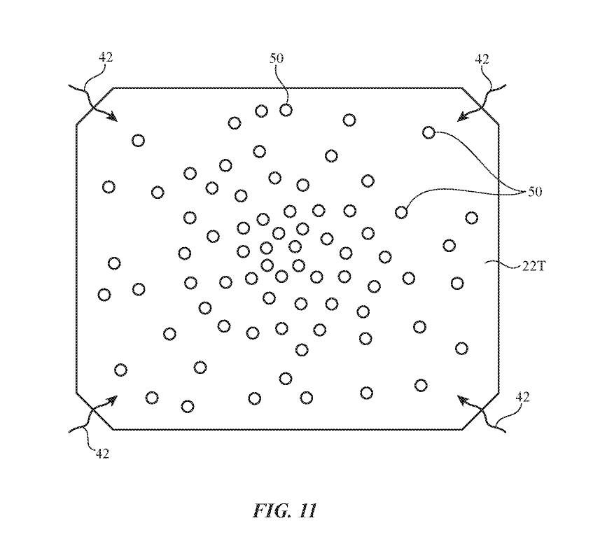

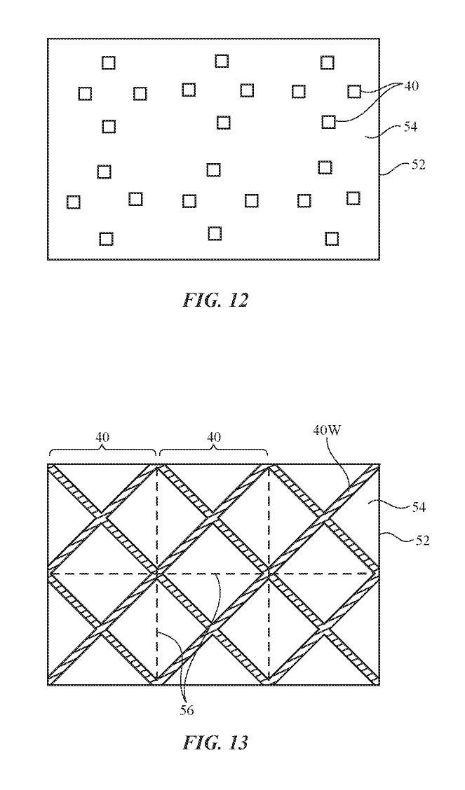

An illustrative arrangement for forming multidirectional light-emitting diodes 40 is shown in FIGS. 12 and 13. Initially, a printed circuit board substrate such as substrate 52 of FIG. 12 may be populated with an array of light-emitting diode dies 40D (i.e., dies 40D may be soldered to metal traces in substrate 52) and may be coated with capping material 54 (e.g., an encapsulating photoluminescent material such as white phosphor and/or a clear encapsulation material). Laser drilling, mechanical cutting (e.g., using a grinding tool, saw, or other groove formation equipment) may then be used to form grooves in layer 54. As shown in FIG. 13, these grooves may have a diagonal lattice pattern and may be filled with white polymer or other suitable reflective material to form reflective walls 40W. The reflective material may optionally be formed on the top of the diodes in addition to forming reflective walls 40W to help confine emitted light 42. Substrate 52 may then be singulated to form individual light-emitting diodes 40 by die cutting or laser cutting substrate 52 along lines 56.

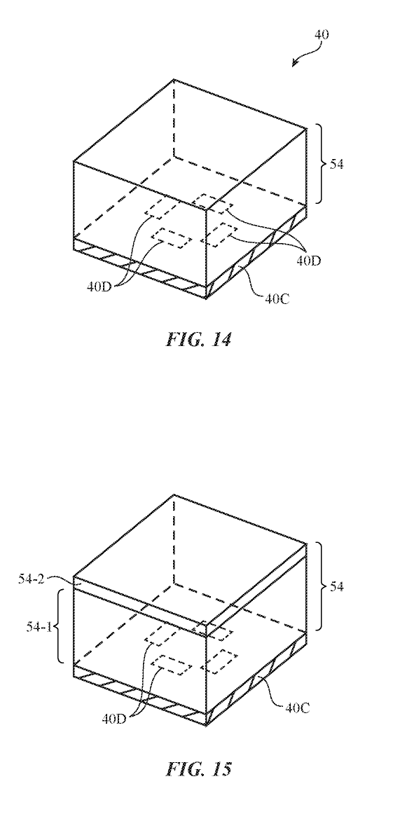

Perspective views of illustrative multidirectional packaged light-emitting diodes 40 are shown in FIGS. 14 and 15. The example of FIG. 14 shows how encapsulant 54 (e.g. phosphor, clear encapsulation material, etc.) may be used to cover dies 40. If desired, some of the white polymer that forms reflective walls 40W or other reflective material may be formed on top of phosphor or other encapsulant. As shown in FIG. 15, for example, capping layer 54 may be formed from encapsulant 54-1 (e.g., phosphor, etc.) and from white reflective layer 54-2 on the upper surface of encapsulant 54-1.

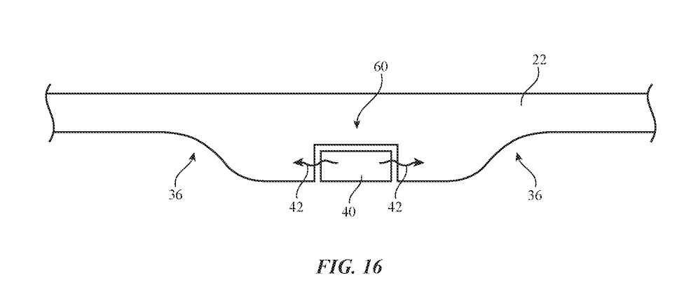

If desired, ramped regions 36 may be incorporated into light guide plate 22 in configurations in which light guide plate 22 receives light from multidirectional light-emitting diodes 40 (e.g., two-direction diodes 40, four-direction diodes 40, etc.). A cross-sectional side view of a portion of a light guide plate of this type is show in FIG. 16. As shown in FIG. 16, light guide plate 22 may have edges 38 and ramped portions 36 that receive light 42 that is emitted from light-emitting diode 40 in multiple different directions (e.g., two different directions or four different directions). Light-emitting diode 40 may, for example, be mounted in a recess such as recess 60 in a thick region of light-guide plate 22.

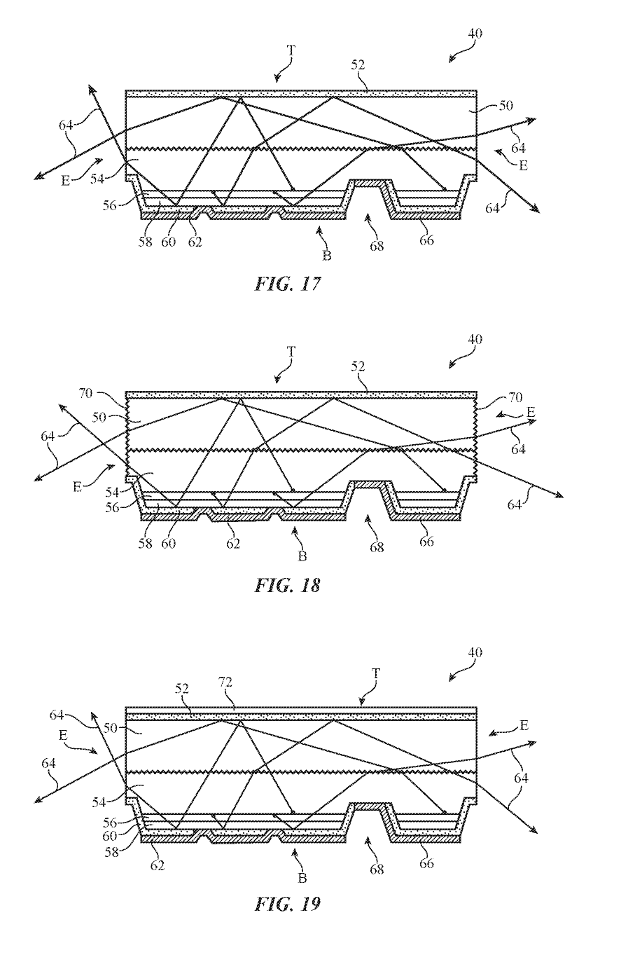

Light-emitting diodes 40 may be formed using a flip-chip configuration of the type shown in FIG. 17. Diode 40 of FIG. 17 has sapphire substrate 50. A layer of n-type GaN such as GaN layer 54 is deposited on a patterned surface of sapphire substrate 50. P-type GaN layer 56 is formed on layer 54. Passivation layer 58 is formed on layer 54. Lower distributed Bragg reflector layer 60 is formed on passivation layer 58 and upper distributed Bragg reflector layer 52 is formed on substrate 50. Passivation layer 58 and layer 60 are patterned and opening 68 is formed through layer 56. A patterned metal layer may be used to form p-type contact 62 along the side of diode 40 and may be used to form n-type contact 66 through opening 68.

After fabrication, diode 40 may be flipped (into the flipped orientation of FIG. 17), so that layer 52 is on the top T of diode 40 and so that contacts 62 and 66 are on the bottom B of diode 40. Contacts 62 and 66 may be soldered to a printed circuit or other suitable substrate. When current is applied to diode 40 through contacts 62 and 66, light 64 is produced and is emitted out of the edge surfaces E of diode 40. Distributed Bragg reflector layers 60 and 52 on bottom surface B and top surface T of diode 40, respectively, prevent light 64 from escaping in the up or down directions. By concentrating light 64 out of the edges of diode 40, diodes 40 can effectively emit light into the edges of light-guide plate 22.

If desired, coatings, treated surfaces, and/or other microstructures may be added to edge surfaces E of diode 40, as illustrated by microstructures 70 of FIG. 18. Microstructures 70 may be formed by roughening or otherwise patterning edge surfaces E, by coating edge surfaces E with thin-film layers such as passivation layers, antireflection coatings, photoluminescent coatings, etc., or by otherwise modifying edge surfaces E. Microstructures 70 may help reduce internal reflections to enhance light emission, may be used to modify the color of emitted light 64, etc.

As shown in the example of FIG. 19, a metal layer such as metal layer 72 may be formed on top of distributed Bragg reflector layer 52. Distributed Bragg reflector layers 52 and 60 may be formed from stacks of thin-film dielectric layers with alternating high and low refractive indices (and/or thin-film layers with other refractive index values). Examples of materials that may be used in forming the thin-film layers of reflectors 52 and 60 include titanium oxide, silicon oxide, aluminum oxide. A reflector may, for example, be formed from a stack of alternating titanium oxide and silicon oxide thin-film layers or may be formed from a stack of aluminum oxide, titanium oxide, and silicon oxide thin-film layers. Metal layer 72 may help enhance the confinement of light 64 within diode 40 and may therefore help prevent light 64 from being emitted upwardly through top surface T of diode 40.

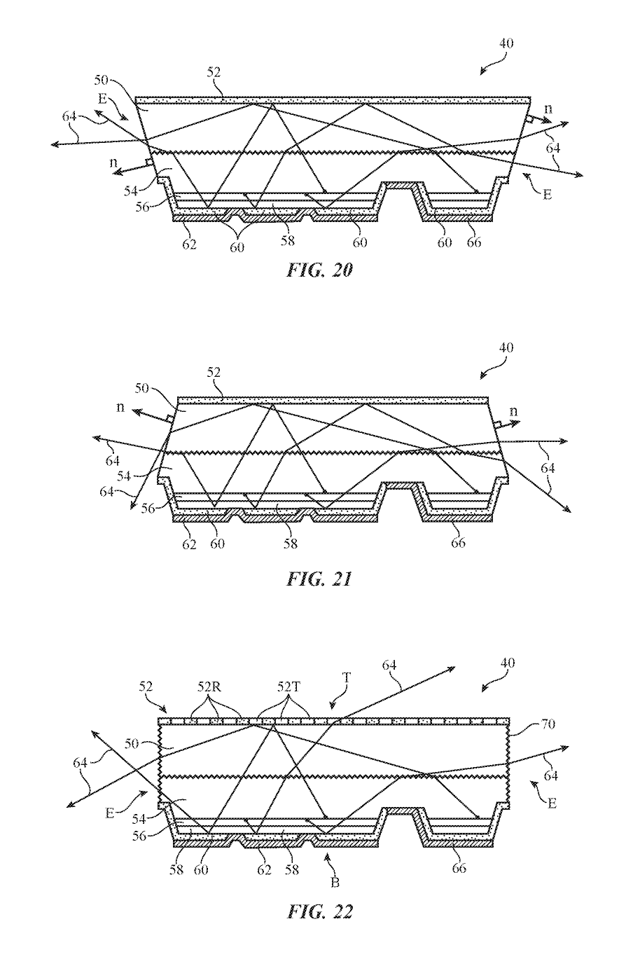

To help direct emitted light 64 in a desired direction, edge surfaces E of diode 40 may be tilted (slanted). In the example of FIG. 20, the surface normal n of planar edge surfaces E has been tilted downwardly to help direct light 64 upwardly. In the example of FIG. 21, the surface normal of planar edge surfaces E has been tilted upwardly to help direct light 64 downwardly.

FIG. 22 is a cross-sectional side view of diode 40 in an illustrative configuration in which distributed Bragg reflector 52 has been patterned (e.g., to form reflecting portions 52R and transparent portions 52T). The presence of transparent portions 52T may allow some of light 64 to be emitted through top surface T (e.g., to help backlight display 14 directly through the thickness of light-guide plate 22).

The foregoing is merely illustrative and various modifications can be made to the described embodiments. The foregoing embodiments may be implemented individually or in any combination.

What is claimed is:

1. A display, comprising:
a liquid crystal display having an array of pixels; and
a backlight that supplies backlight illumination for the array of pixels, wherein the backlight includes a light guide plate with ramped regions that have tapered profiles and includes light-emitting diodes that are overlapped by the light guide plate and that emit light into the ramped regions and wherein light scattered from the light guide plate serves as the backlight illumination for the array of pixels.

2. The display defined in claim 1 wherein the light guide plate comprises thicker regions and thinner regions and wherein each of the ramped regions tapers from a first thickness where the ramped region joins one of the thicker regions to a second thickness that is less than the first thickness where the ramped region joins one of the thinner regions.

3. The display defined in claim 2 wherein some of the ramped regions taper in a first direction and other of the ramped regions tapper in a second direction opposite to the first direction.

4. The display defined in claim 2 wherein the light guide plate includes a plurality of elongated light distribution regions each of which distributes light from a respective one of the light-emitting diodes to form a respective portion of the backlight illumination.

5. The display defined in claim 2 wherein the light-emitting diodes have top, bottom, and edge surfaces and have distributed Bragg reflector layers on the top and bottom surfaces so that the light-emitting diodes emit the light into the ramped regions through the edge surfaces.

6. The display defined in claim 2 wherein the light-emitting diodes each include multiple light-emitting diode dies in a common package.

7. The display defined in claim 2 wherein the light-emitting diodes each include two light-emitting diode dies in a common package.

8. The display defined in claim 2 wherein the light-emitting diodes each include four light-emitting diode dies in a common package.

9. The display defined in claim 8 wherein the package of each of the light-emitting diodes includes white reflective walls between the light-emitting diode dies of that light-emitting diode and wherein the dies in the package of that light-emitting diode include at least two dies that emit light of different colors.

10. A display, comprising:
a liquid crystal display having an array of pixels; and
a backlight that supplies backlight illumination for the array of pixels, wherein the backlight includes a light guide plate with a plurality of rectangular light distribution regions each of which has corners and includes multidirectional light-emitting diodes each of which has multiple light-emitting diode dies in a common package and each of which supplies light to the corners of at least two of the light distribution regions.

11. The display defined in claim 10 wherein the package of each of the light-emitting diodes has a substrate and wherein each of the light-emitting diode dies of that light-emitting die is soldered to the substrate.

12. The display defined in claim 11 wherein the package of each of the light-emitting diodes includes a phosphor layer covering the light-emitting diode dies.

13. The display defined in claim 12 wherein the package of each of the light-emitting diodes includes a reflective wall that is between at least two of the light-emitting diode dies in that package.

14. The display defined in claim 13 wherein the reflective wall comprises white polymer.

15. The display defined in claim 14 wherein the package of each of the light-emitting diodes has a white polymer layer covering the phosphor layer.

16. The display defined in claim 11 wherein at least two of the light-emitting diode dies in each light-emitting diode emit light of different colors.

17. The display defined in claim 16 wherein the light guide plate includes ramped regions that taper between a first thickness associated with first portions of the light guide plate and a second thickness associated with second portions of the light guide plate.

18. A backlight for a display, comprising:
a light guide plate having a plurality of rectangular light distribution regions, each of which has four corners; and
a plurality of multidirectional light-emitting diodes each of which has a package substrate, multiple light-emitting diode dies on the package substrate that emit light in different directions, and a light reflecting wall that extends between the light-emitting diode dies on the package substrate, wherein each of the corners receives light from a respective one of the light-emitting diode dies.

19. The backlight defined in claim 18 wherein each light-emitting diode includes a phosphor layer that covers the light-emitting diode dies in that light-emitting diode.

20. The backlight defined in claim 19 wherein at least two of the light-emitting diode dies in each light-emitting diode emit light of different colors.
